(19) United States
(12) Patent Application Publication
(10) Pub. No.: US 2016/0062883 A1
(43) Pub. Date: Mar. 3, 2016

(54) DATA STORAGE DEVICE AND OPERATING METHOD THEREOF

(71) Applicant: SK hynix Inc., Gyeonggi-do (KR)

(72) Inventor: Eu Joon BYUN, Gyeonggi-do (KR)

(21) Appl. No.: 14/543,591

(22) Filed: Nov. 17, 2014

(30) Foreign Application Priority Data
Aug. 26, 2014 (KR) 10-2014-0111447

(51) Int. Cl. G06F 12/02

(52) U.S. Cl. CPC G06F 12/0246; G06F 2212/7201

(57) ABSTRACT

A data storage device may include: a nonvolatile memory device; and a controller suitable for generating a mapping table based on one or more of write logical addresses for access to the nonvolatile memory device. The mapping table may include information of: correspondence between a physical address for access to the nonvolatile memory device and one of the write logical addresses; and a number of successive physical addresses corresponding to successive logical addresses starting from the write logical addresses corresponding to the correspondence information.

### CROSS-REFERENCES TO RELATED APPLICATION

The present application claims priority under 35 U.S.C. §119(a) to Korean application number 10-2014-0111447, filed on Aug. 25, 2014, in the Korean Intellectual Property Office, which is incorporated herein by reference in its entirety.

### BACKGROUND

1. Technical Field

Various embodiments relate to a data storage device and, more particularly, to a data storage device including a nonvolatile memory device.

2. Related Art

A semiconductor memory device stores data. Semiconductor memory devices may be categorized into nonvolatile and volatile memory devices.

Nonvolatile memory devices retain data, even without power. Nonvolatile memory devices include flash memory devices such as NAND Flash or NOR Flash, FeRAM (Ferroelectrics Random Access Memory), PCRAM (Phase-Change Random Access Memory), MRAM (Magnetic Random Access Memory), or ReRAM (Resistive Random Access Memory).

Volatile memory devices cannot retain stored data without a power source. Volatile memory devices include SRAM (Static Random Access Memory), DRAM (Dynamic Random Access Memory) or the like. Volatile memory devices may be used as a buffer memory device, a cache memory device, or a working memory device in a data processing system, based on their relatively high processing speed.

### SUMMARY

In an embodiment of the present disclosure, a data storage device may include: a nonvolatile memory device; and a controller suitable for generating a mapping table based on one or more of write logical addresses for access to the nonvolatile memory device. The mapping table may store information including: correspondence between a physical address for access to the nonvolatile memory device and one of the write logical addresses; and a number of successive physical addresses corresponding to successive logical addresses starting from the write logical addresses corresponding to the correspondence information.

In an embodiment of the present disclosure, a data storage device may include: a nonvolatile memory device accessible by a physical address corresponding to a write logical address; and a controller suitable for counting a number of successive physical addresses corresponding to successive logical addresses starting from one of write logical addresses.

In an embodiment of the present disclosure, an operating method of a data storage device may include the steps of: receiving one or more write logical addresses for access to a nonvolatile memory device; and generating a mapping table comprising information including: correspondence between a physical address for access to the nonvolatile memory device and one of the write logical addresses; and a number of successive physical addresses corresponding to successive logical addresses starting from the write logical addresses corresponding to the correspondence information.

### BRIEF DESCRIPTION OF THE DRAWINGS

Features, aspects, and embodiments are described in conjunction with the attached drawings, in which:

FIG. 1 is a block diagram illustrating a data storage device according to an embodiment of the present disclosure;

FIG. 2 is a flowchart illustrating an operating method of a data storage device according to an embodiment of the present disclosure;

FIG. 3 is a schematic diagram illustrating a L2P mapping table according to an embodiment of the present disclosure;

FIG. 4 is a flowchart illustrating an operating method of a data storage device according to an embodiment of the present disclosure;

FIG. 5 is a schematic diagram illustrating a L2P mapping table according to an embodiment of the present disclosure;

FIG. 6 is a flowchart illustrating an operating method of a data storage device according to an embodiment of the present disclosure;

FIG. 7 is a schematic diagram illustrating a L2P mapping table and a P2L mapping table according to an embodiment of the present disclosure;

FIG. 8 is a flowchart illustrating an operating method of a data storage device according to an embodiment of the present disclosure; and

FIG. 9 is a schematic diagram illustrating a P2L mapping table according to an embodiment of the present disclosure.

### DETAILED DESCRIPTION

A data storage device and an operating method thereof according to the present disclosure will be described below with reference to the accompanying drawings through exemplary embodiments.

FIG. 1 is a block diagram illustrating a data storage device 10 according to an embodiment of the present disclosure.

The data storage device 10 may store data provided from an external device (not illustrated) in response to a write request of the external device. Furthermore, the data storage device 10 may provide the stored data to the external device in response to a read request of the external device. The data storage device 10 may include a PCMCIA (Personal Computer Memory Card International Association) card, a CF (Compact Flash) card, a smart media card, a memory stick, various multi media cards (MMC, eMMC, RS-MMC, and MMC-micro SD (Secure Digital) cards (SD, Mini-SD, and Micro-Sly), UFS (Universal Flash Storage), or a solid state drive (SSD).

The data storage device 10 may include a controller 100 and a nonvolatile memory device 200.

The controller 100 may include a processor 110 and a memory 120.

The processor 110 may control overall operations of the data storage device 10. The processor 110 may control a write operation or read operation of the nonvolatile memory device 200 in response to a write request or read request of an external device. The processor 110 may run a software program on the memory 120 to control the operation of the data storage device 10.

The processor 110 may generate mapping information and sequence information on a logical address provided from the external device. The nonvolatile memory device 200 may work with a physical address system different from a logical address system identifiable to the external device. For this reason, the processor 110 may generate the mapping information indicating correspondence between a logical address and a physical address, convert the logical address provided from the external device into the physical address, and provide the physical address to the nonvolatile memory device 200.

The processor 110 may generate the sequence information for each and every logical address inputted to the data storage device 10. The sequence information may indicate a number of successive physical addresses, which are sequentially mapped to successive logical addresses starting from the corresponding logical address, for example the logical address inputted to the data storage device 10.

Once the mapping information and the sequence information are generated, the processor 110 may identify the successive logical addresses from a reference logical address, which may be inputted from an external device with an access request to the memory cell array 250, and the successive physical addresses corresponding to the successive logical addresses through the mapping information and sequence information in an indirect way. The indirect way means that the processor 110 may eventually identify the successive physical addresses for access to the memory cell array 250 of the nonvolatile memory device 200 by using the reference logical address, the mapping information and the sequence information instead of directly referring to the successive logical addresses or the successive physical addresses.

The processor 110 may construct one or more logical-to-physical (L2P) mapping tables and a physical-to-logical mapping table (P2L) table to be stored in the memory 120, based on mapping information and sequence information of a logical address, The processor 110 may back up the constructed mapping table into the nonvolatile memory device 200 from the memory 120.

The memory 120 may serve as a working memory, a buffer memory, or a cache memory of the processor 110. The memory 120 may store various program data and software programs run by the processor 110, buffer data transmitted between the external device and the nonvolatile memory device 200, or temporarily store cache data.

The nonvolatile memory device 200 may include a control logic 210, an interface unit 220, an address decoder 230, a data input/output unit 240, and a memory cell array 250.

The control logic 210 may control overall operations such as write operations, read operations, and erase operations of the nonvolatile memory device 200 in response to commands provided from the controller 100.

The interface unit 220 may exchange various control signals and data with the controller 100, the various control signals including a command and the physical address. The interface unit 220 may transmit the various control signals and the data to internal units of the nonvolatile memory device 200.

The address decoder 230 may decode the received physical address, for example, a row address and a column address. The address decoder 230 may selectively drive word lines WL according to the decoding result of the row address. The address decoder 230 may control the data input/output unit 240 to selectively drive bit lines BL according to the decoding result of the column address.

The data input/output unit 240 may transmit the data received from the interface unit 220 to the memory cell array 250 through the bit lines BL. The data input/output unit 240 may transmit data read through the bit lines BL from the memory cell array 250 to the interface unit 220.

The memory cell array 250 may include a plurality of memory cells (not illustrated) arranged at the respective intersections between the word lines WL and the bit lines BL. The memory cell array 250 may perform an erase operation on a memory block basis, and perform a write operation or read operation on a page basis. The memory cell array 250 may be accessed on the basis of a physical address allocated on a memory block basis or page basis.

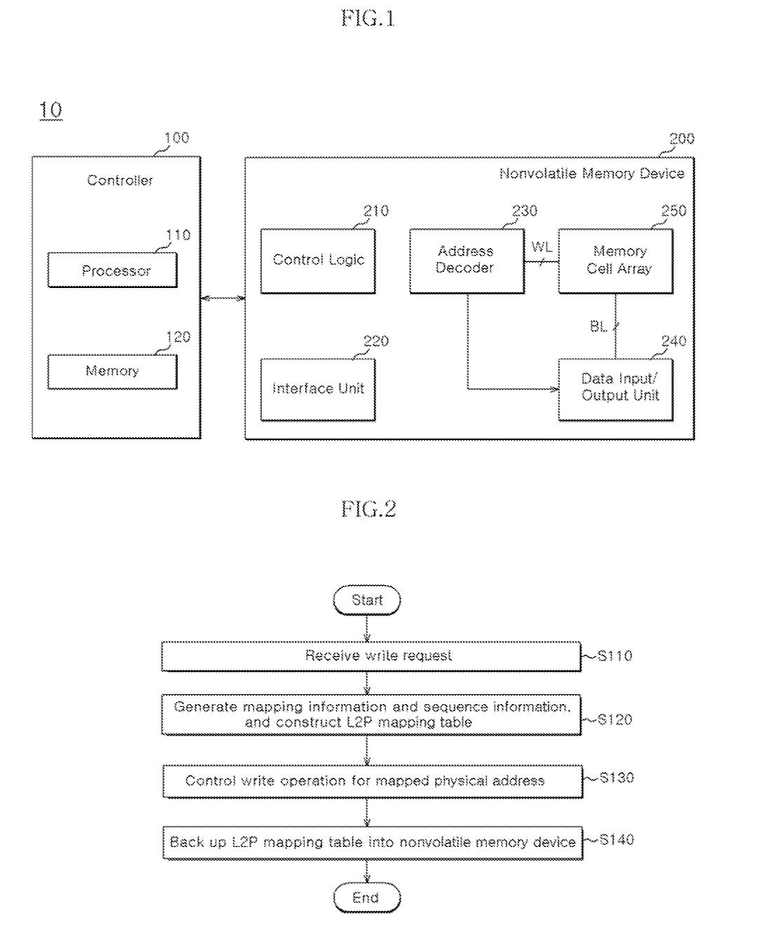

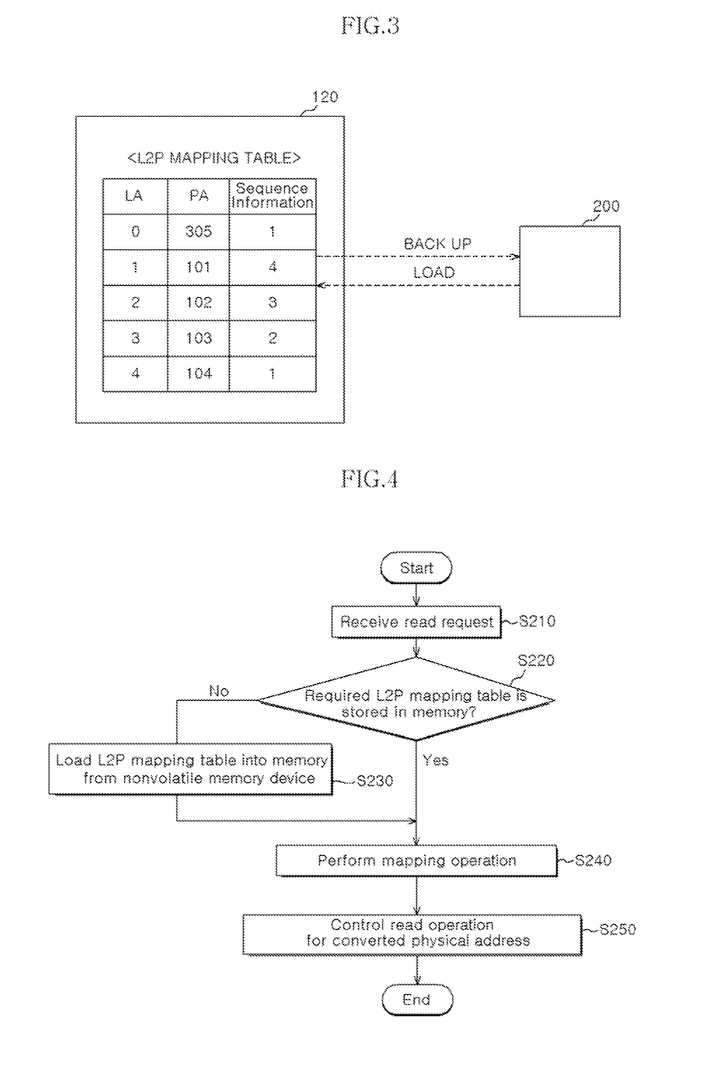

FIG. 2 is a flowchart illustrating an operating method of the data storage device 10 according to an embodiment of the present disclosure. FIG. 3 is a schematic diagram illustrating a L2P mapping table according to an embodiment of the present disclosure. The controller 100 may construct and manage the L2P mapping table as shown in FIG. 3. Hereafter, referring to FIGS. 1 to 3 the operating method of the controller 100 will be described in detail.

At step S110, the controller 100 may receive a write request as the access request to the memory cell array 250 from an external device. The write request may be provided with a logical address identifiable to the external device.

At step S120, the controller 100 may generate mapping information and sequence information on the provided logical address, and construct the L2P mapping table based on the generated mapping information and sequence information.

For example, the L2P mapping table may include fields for the logical address, the physical address, and the sequence information. The fields of the logical address and the physical address may represent the mapping information. The fields of the physical address and the sequence information may represent the sequence information. The L2P mapping table may be indexed through the logical address.

The mapping information may represent the correspondence between the logical address and the physical address. The sequence information may represent the number of successive physical addresses, which are sequentially mapped to successive logical addresses starting from the corresponding logical address, for example the provided logical address. When a certain physical address does not have the following successive physical address, the value of the sequence information corresponding to the certain physical address may be 1 in the L2P mapping table.

Referring to FIG. 3, for example, when the controller 100 receives the logical address LA having a value of 0 with the write request for random data, the controller 100 may map the logical address LA of 0 to the physical address PA having a value of 305 in the L2P mapping table. The controller 100 may set the value of sequence information for the logical address LA of 0 to 1 because the physical address of 305 corresponding to the logical address LA of 0 does not have the following successive physical address.

For example, when the controller 100 receives the successive logical addresses LA respectively having values of 1, 2, 3, and 4 with the write request for sequential data, the controller 100 may sequentially map successive physical addresses PA respectively having values of 101, 102, 103 and 104 to the logical addresses LA of 1, 2, 3, and 4. The controller 100 may set the value of sequence information for the logical address LA of 1 to 4 representing the number of the successive physical addresses PA of 101, 102, 103, and 104 starting from the corresponding physical address PA of 101. The controller 100 may set the value of sequence information for the logical address LA of 2 to 3 representing the number of the successive physical addresses PA of 102, 103, and 104 starting from the corresponding physical address PA of 102. The controller 100 may set the value of sequence information for the logical address LA of 3 to 2 representing the number of the successive physical addresses PA of 103 and 104 starting from the corresponding physical address PA of 103. The controller 100 may set the value of sequence information for the logical address LA of 4 to 1 representing the number of successive physical addresses PA of 104 starting from the corresponding physical address PA of 104, which does not have the following successive physical address.

Referring back to FIG. 2, at step S130 the controller 100 may control a write operation of the nonvolatile memory device 200 with the mapped physical addresses of the L2P mapping table constructed by the controller 100 at step S120. The nonvolatile memory device 200 may store write request data in a memory area corresponding to the mapped physical addresses.

At step S140, the controller 100 may back up the L2P mapping table into the nonvolatile memory device 200. The backed-up L2P mapping table may be retained even though power is turned off, and loaded into the memory 120 when power is turned on or a mapping operation is required.

FIG. 4 is a flowchart illustrating an operating method of the data storage device 10 according to an embodiment of the present disclosure. FIG. 5 is a schematic diagram illustrating the L2P mapping table according to an embodiment of the present disclosure. The controller 100 may perform a mapping operation by referring to the L2P mapping table as shown in FIG. 5.

Referring to FIGS. 1, 3, 4 and 5, an operating method of the controller 100 will be described.

In step S210, the controller 100 may receive a read request as the access request to the memory cell array 250 from an external device. The read request may be provided with the reference logical address identifiable by the external device. For example, the read request may be provided with the logical address LA of 0 as the reference logical address. For example, the read request may be provided with successive logical addresses LA of 1, 2, 3, and 4, the reference logical address of which may be the logical address LA of 1.

At step S220, the controller 100 may determine whether an L2P mapping table required for a mapping operation is stored in the memory 120. The controller 100 may determine that the L2P mapping table required for a mapping operation with the reference logical address LA, for example the logical address LA of 0 or 1, is stored in the memory 120 based on a result obtained by referring to the memory 120. When the required L2P mapping table is not stored in the memory 120 (No), the procedure may proceed to step S230, When the required L2P mapping table is stored the memory 120 (Yes), the procedure may proceed to step S240.

At step S230, the controller 100 may load the required L2P mapping table into the memory 120 from the nonvolatile memory device 200. Generally, the L2P mapping table is relatively large and it may not be capable of being stored in the memory 120 in its entirety, and therefore the controller 100 may load the L2P mapping table on a predetermined basis, for example, on a 4-kbyte basis in consideration of the capacity of the memory 120. For convenience of description, suppose that the controller 100 may load two entries as a loading unit of the L2P mapping table as illustrated in FIG. 5. The controller 100 may load a part, for example, the two entries as the loading unit of the L2P mapping table including the entry of the reference logical address, for example the logical address LA of 0 or 1 provided with the read request, into the memory 120 from the nonvolatile memory device 200.

At step S240, the controller 100 may perform a mapping operation of converting the logical address provided with the access request into the physical address by referring to the L2P mapping table stored in the memory 120. For example, the controller 100 may convert the reference logical address LA of 0 provided with the read request into the physical address PA of 305. For example, the controller 100 may convert the logical address LA of 1, which is the reference logical address of the successive logical addresses LA of 1 to 4 provided with the read request, into the physical address PA of 101 by referring to the L2P mapping table stored in the memory 120. Furthermore, since the value of sequence information on the reference logical address LA of 1 is 4, the controller 100 may determine that four successive physical addresses, a sequence of which starts from the physical address PA of 101 corresponding to the reference logical address, are sequentially mapped to the successive logical addresses LA of 1, 2, 3, and 4. Thus, the controller 100 may calculate the physical addresses PA of 102, 103, and 104 mapped to the rest of the successive logical addresses LA of 2, 3, and 4.

At step S250, the controller 100 may control a read operation of the nonvolatile memory device 200 with the physical address converted through the L2P mapping table at step S240. The nonvolatile memory device 200 may read out read request data from a memory area corresponding to the physical address converted by the controller 100.

In short, the controller 100 may indirectly identify the successive physical addresses mapped to the successive logical addresses succeeding the reference logical address through the mapping information and sequence information on the reference logical address of the L2P mapping table loaded on the memory 120 during the mapping operation for the successive logical addresses provided with the read request.

As described above, the reference logical address may be defined as an address of one or more successive logical addresses provided with the access request, of which the mapping information and sequence information are referred to by the controller 100 in order to indirectly identify the physical addresses mapped to the successive logical addresses during the mapping operation. For example, in the embodiment described with reference to FIGS. 4 and 5, the logical address LA of 1 among the successive logical addresses LA of 1, 2, 3, and 4 may be the reference logical address. Among the successive logical addresses provided with the read request, a logical address, of which the mapping information and sequence information are loaded on the memory 120, can be set to the reference logical address. The reference logical address may not need to be the first address of one or more successive logical addresses provided with the access request.

As described above, when the controller 100 “indirectly” identifies the successive physical addresses mapped to the successive logical addresses, it may indicate that the successive logical addresses are not “directly” referred to but the sequence information of the reference logical address are referred to for the conversion into the successive physical addresses through the L2P mapping table. The successive physical addresses mapped to the successive logical addresses may be calculated by increasing the value of the physical address mapped to the reference logical address by 1.

The number of successive physical addresses which can be indirectly identified by the controller 100 may be smaller than the value of the sequence information. The controller 100 may directly convert a logical address deviating from the value of the sequence information, among the successive logical addresses corresponding to the read request, into a physical address by referring to mapping information on the corresponding logical address. When the mapping information on the logical address deviating from the value of the sequence information does not exist on the memory 120, the controller 100 may additionally load a required L2P mapping table from the nonvolatile memory device 200.

When mapping operations can be performed with the successive logical addresses provided with the access request through the mapping information and sequence information of the reference logical address, the L2P mapping table for the rest of the successive logical addresses succeeding the reference logical address does not need to be loaded into the memory 120 from the nonvolatile memory device 200. Thus, the data storage device 10 may process a read operation at a higher speed. Furthermore, since the entire L2P mapping table of sequential data occupying a large amount of space does not need to be loaded into the memory 120, the capacity of the memory 120 may be more efficiently utilized.

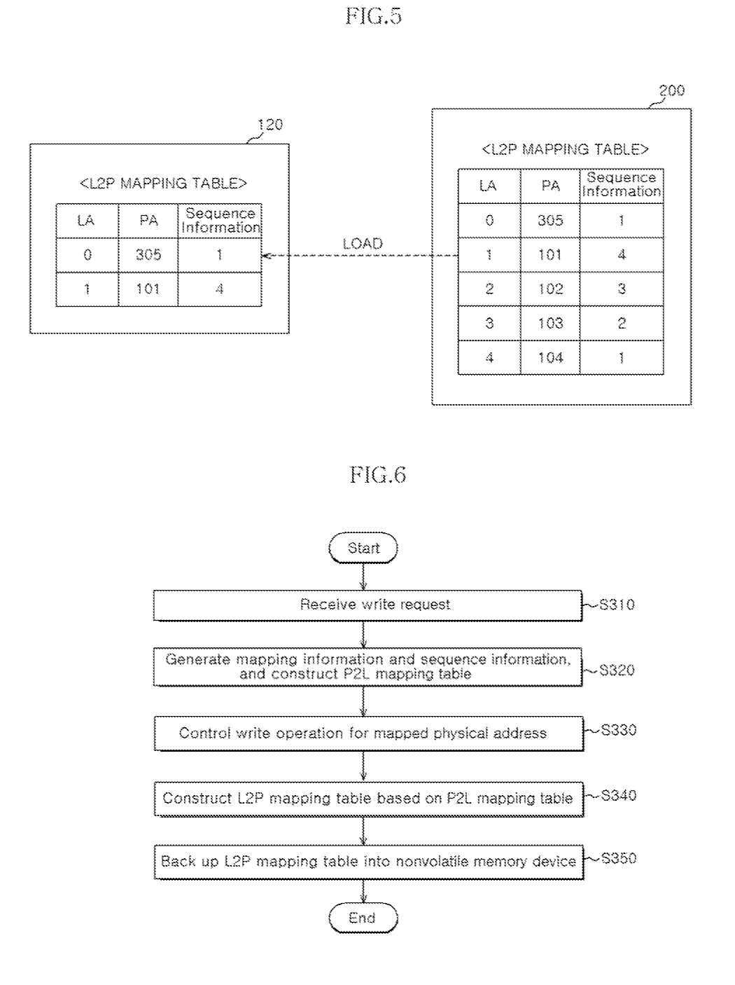

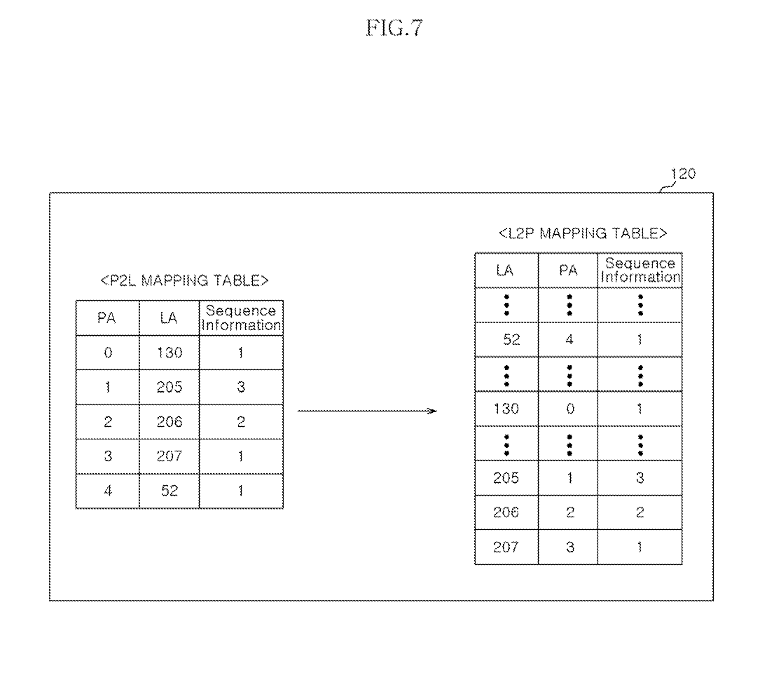

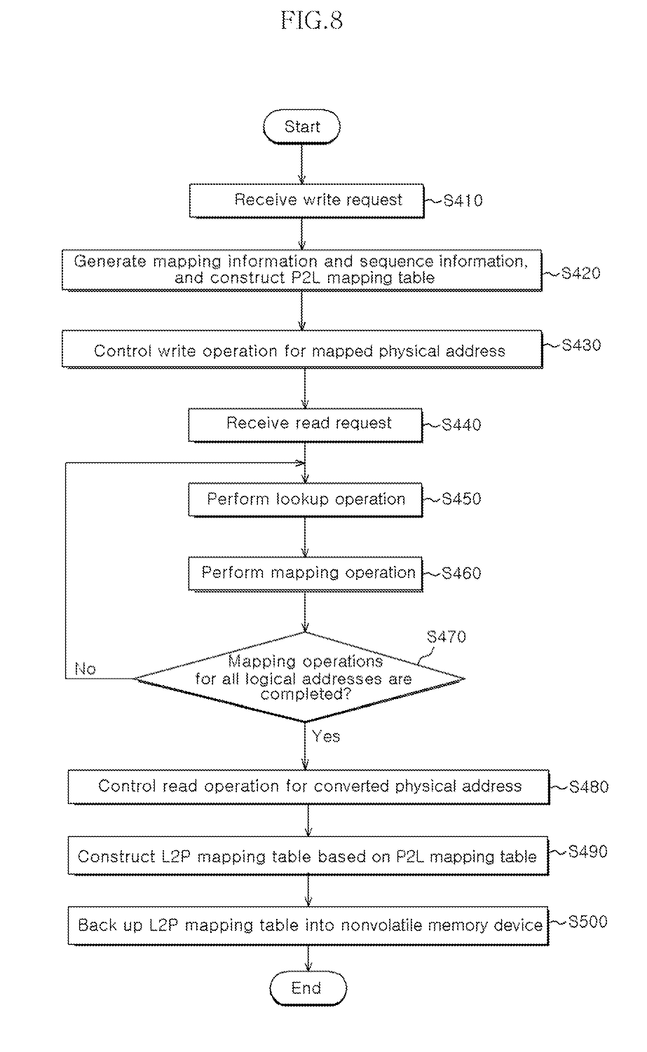

FIG. 6 is a flowchart illustrating an operating method of the data storage device 10 according to an embodiment of the present disclosure. FIG. 7 is a schematic diagram illustrating a L2P mapping table and a P2L mapping table according to an embodiment of the present disclosure. The controller 100 may construct and manage the P2L mapping table as shown in FIG. 7. Referring to FIGS. 1, 6 and 7, the operating method of the controller 100 will now be described in detail.

At step S310, the controller 100 may receive a write request as the access request to the memory cell array 250 from an external device. The write request may be provided with the logical address identifiable by the external device. For example, the write request may be provided with the logical address LA of 130. For example, the write request may be provided with the successive logical addresses LA of 205, 206 and 207. For example the write request may be provided with the logical address LA of 52.

At step S320, the controller 100 may generate napping information and sequence information on the provided logical address, and construct the P2L mapping table based on the generated mapping information and sequence information. For example, the P2L mapping table may have the same fields as the L2P mapping table described above with reference to FIGS. 2 and 3 except that the P2L mapping table may be indexed through the physical address.

Referring to FIG. 7, for example, when the controller 100 receives the logical address LA having a value of 130 with the write request for random data, the controller 100 may map the physical address PA having a value of 0 to the logical address LA of 130 in the P2L mapping table. The controller 100 may set the value of sequence information for the logical address LA of 130 to 1 because the physical address of 0 corresponding to the logical address LA of 130 does not have the following successive physical address.

For example, when the controller 100 receives the successive logical addresses LA respectively having values of 205, 206, and 207 with the write request for sequential data, the controller 100 may sequentially map the successive physical addresses PA respectively having values of 1, 2, and 3 to the logical addresses LA of 205, 206, and 207 in the P2L mapping table. The controller 100 may set the value of sequence information for the logical address LA of 205, and it may be set to 3 representing the number of the successive physical addresses PA of 1, 2, and 3 starting from the corresponding physical address PA of 1. The controller 100 may set the value of sequence information for the logical address LA of 206 to 2, representing the number of successive physical addresses PA of 2 and 3 starting from the corresponding physical address PA of 2. The controller 100 may set the value of sequence information for the logical address LA of 207 to 1, representing the number of successive physical addresses PA of 3 starting from the corresponding physical address PA of 3, which does not have the following successive physical address.

For example, when the controller 100 receives the logical address LA having a value of 52 with the write request for random data, the controller 100 may map the physical address PA having a value of 4 to the logical address LA of 52 in the P2L mapping table. The controller 100 may set the value of sequence information for the logical address LA of 52 to 1 because the physical address of 4, corresponding to the logical address LA of 52, does not have the following successive physical address.

Referring back to FIG. 6, at step S330, the controller 100 may control a write operation of the nonvolatile memory device 200 with the mapped physical addresses of the P2L mapping table constructed by the controller 100 at step S320. The nonvolatile memory device 200 may store write request data in a memory area corresponding to the mapped physical addresses.

At step S340, the controller 100 may construct the L2P mapping table based on the P2L mapping table. Referring to FIG. 7, the P2L mapping table and the L2P mapping table may be configured in a reverse relationship. For example, the L2P mapping table shown in FIG. 7 may have the same fields as the L2P mapping table described above with reference to FIGS. 2 and 3.

At step S350, the controller 100 may back up the L2P mapping table into the nonvolatile memory device 200. The backed-up L2P mapping table may be retained even though power is turned off, and loaded into the memory 120 when power is turned on or a mapping operation is required.

According to the operating method described with reference to FIGS. 6 and 7, the controller 100 may construct the P2L mapping table before constructing the L2P mapping table, and periodically update the recent mapping information and sequence information included in the P2L mapping table into the L2P mapping table.

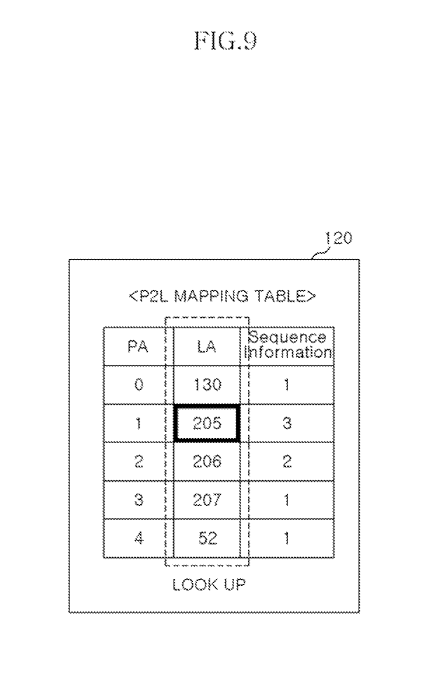

FIG. 8 is a flowchart illustrating an operating method of the data storage device 10 according to an embodiment of the present disclosure, FIG. 9 is a schematic diagram illustrating the P2L mapping table according to an embodiment of the present disclosure. The controller 100 may perform a mapping operation by referring to the P2L mapping table as shown in FIG. 9.

Hereafter, referring to FIGS. 1, 7, 8 and 9, the operating method of the controller 100 will be described. The operating method illustrated in FIG. 8 may be the same as the operating method described above with reference to FIGS. 6 and 7 except for steps S440 to S480 between steps S430 and S490. Steps S410, S420, S430, S490, and S500 may be the same as steps S310, S320, S330, S340, and S350 described above with reference to FIGS. 6 and 7. Thus, the following descriptions will be focused on steps S440 to S480.

At step S440, the controller 100 may receive a read request as the access request to the memory cell array 250 from an external device. The read request may be provided with the logical address identifiable by the external device. For example, the read request may be provided with the successive logical addresses LA having values of 205, 206, and 207, the reference logical address of which may be the logical address LA of 205.

At step S450, the controller 100 may perform a lookup operation on the P2L mapping table. When the recent mapping information and sequence information have been preferentially reflected into the P2L mapping table, the controller 100 may perform the lookup operation of searching for the logical address LA of 205 among the logical addresses LA of 205, 206, and 207 provided with the read request among all entries of the P2L mapping table, that is, all logical addresses of the P2L mapping table, The controller 100 may read out mapping information and sequence information on the logical address LA of 205 as a result of the lookup operation. The logical address LA of 205 may be a reference logical address.

At step S460, the controller 100 may perform a mapping operation by referring to the mapping information and sequence information read as the result of the lookup operation of step S450. The controller 100 may convert the reference logical address LA of 205 into the physical address PA of 1 by referring to the read mapping information of the P2L mapping table. Furthermore, since the value of sequence information for the reference logical address LA of 205 is 3, the controller 100 may determine that three successive physical addresses of 1 to 3 are sequentially mapped to the logical addresses LA of 205, 206, and 207 provided with the read request. Thus, the controller 100 may calculate the physical addresses PA of 2 and 3, which are mapped to the rest of the successive logical addresses LA of 206 and 207 succeeding the reference logical address LA of 205.

At step S470, the controller 100 may determine whether the mapping operations with all of the successive logical addresses provided with the read request are completed.

When the physical addresses mapped to the successive logical addresses are indirectly converted through the mapping information and sequence information for the reference logical address LA of 205 in the P2L mapping table, the controller 100 may determine that the mapping operations are completed (Yes), and the procedure may proceed to step S480.

At step S480, the controller 100 may control′ the read operation of the nonvolatile memory device 200 with the successive physical addresses converted at step S460. The nonvolatile memory device 200 may read out read-requested data from a memory area corresponding to the successive physical addresses converted by the controller 100 at step S460.

When it is determined at step S470 that the physical addresses mapped to all the successive logical addresses corresponding to the read request cannot be indirectly identified through the reference logical address, the controller 100 may determine that the mapping operations for all the logical addresses corresponding to the read request are not completed (No), and the procedure may proceed to step S450. As described above, the number of successive physical addresses which can be indirectly identified by the controller 100 is smaller than the value of the sequence information. Thus, when the number of successive logical addresses corresponding to the read request exceeds the value of the sequence information on the reference logical address, the controller 100 may not indirectly identify physical addresses mapped to all the successive logical addresses corresponding to the read request.

At step S450, the controller 100 may perform the lookup operation of searching for the logical address in the P2L mapping table, with which the mapping operation is not completed.

In short, the controller 100 may read out mapping information and sequence information for the reference logical address through the lookup operation to the Pa mapping table in response to the read request provided with the successive logical addresses. When the value of the read sequence information of a certain physical address is not 1, which means that the certain physical address has the following successive physical address, the successive physical addresses mapped to the successive logical addresses succeeding the reference logical address may be indirectly identified.

The lookup operation to the P2L mapping table accompanies the search operation for all of the logical addresses stored in the P2L mapping table. Thus, it is burdensome that the lookup operations for all of the successive logical addresses are performed one by one. According to an embodiment of the present disclosure, the lookup operation may be omitted for the logical addresses which can be indirectly converted into the physical addresses through the mapping information and sequence information for the reference logical address of the P2L mapping table and the L2P mapping table. Thus, the data storage device 10 may process read operations at a higher speed.

According to the embodiments of the present disclosure, the data storage device may operate at an improved processing speed.

While certain embodiments have been described above, it will be understood to those skilled in the art that the embodiments described are examples only. Accordingly, the inventive concept should not be limited based on the described embodiments. Rather, the legal protection for the inventive concept should only be limited by the claims that follow when taken in conjunction with the above description and accompanying drawings.

What is claimed is:

1. A data storage device comprising:
a nonvolatile memory device; and
a controller suitable for generating a mapping table based on one or more write logical addresses for access to the nonvolatile memory device,
wherein the mapping table has information including:
correspondence between a physical address for access to the nonvolatile memory device and one of the write logical addresses; and
a number of successive physical addresses corresponding to successive logical addresses starting from the write logical addresses corresponding to the correspondence information.

2. The data storage device according to claim 1, wherein the mapping table is indexed by the write logical address, and the physical address and the number of successive physical addresses are mapped to the write logical address.

3. The data storage device according to claim 1, wherein the mapping table is indexed by the physical address, and the write logical address and the number of successive physical addresses are mapped to the physical address.

4. The data storage device according to claim 1, wherein when the controller is provided with one or more read logical addresses, the controller identifies the successive physical addresses based on the read logical addresses and the mapping table.

5. The data storage device according to claim 4, wherein the number of the identified physical addresses is equal to or less than the number of successive physical addresses corresponding to the read logical addresses.

6. The data storage device according to claim 1, wherein the controller generates a L2P mapping table, which is indexed by the write logical address, and the physical address and the number of successive physical addresses are mapped to the write logical address, based on a P2L mapping table, which is indexed by the physical address, and the write logical address and the number of successive physical addresses are mapped to the physical address, and backs up the L2P mapping table into the nonvolatile memory device.

7. A data storage device comprising:
a nonvolatile memory device accessible by physical addresses that correspond to write logical addresses; and
a controller suitable for generating a number of successive physical addresses corresponding to successive logical addresses starting from one of the write logical addresses.

8. The data storage device according to claim 7, wherein the controller further generates information of correspondence between a physical address and one of the write logical addresses corresponding to the number of successive physical addresses.

9. The data storage device according to claim 8, wherein when the controller is provided with one or more read logical addresses, the controller identifies the successive physical addresses based on the read logical addresses and the information of the correspondence and the number of successive physical addresses.

10. The data storage device according to claim 9,
wherein the controller comprises a memory, and
wherein the controller searches for the information of the correspondence and a number corresponding to one of the read logical addresses in the memory.

11. The data storage device according to claim 10, wherein the controller loads the information of the correspondence and the number from the nonvolatile memory device into the memory in order to search for the information of the correspondence and the number corresponding to one of the read logical addresses.

12. An method of operating a data storage device, comprising the steps of:
receiving one or more write logical addresses for access to a nonvolatile memory device; and
generating a mapping table comprising information of:
correspondence between a physical address for access to the nonvolatile memory device and one of the write logical addresses; and
a number of successive physical addresses corresponding to successive logical addresses starting from the write logical addresses corresponding to the correspondence information.

13. The operating method according to claim 12,
wherein the generating of the mapping table generates the mapping table in a memory, and
further comprising backing up the mapping table into the nonvolatile memory device.

14. The operating method according to claim 13, further comprising:
receiving read logical addresses for access to the nonvolatile memory device; and
identifying the successive physical addresses based on the read logical addresses and the information of the correspondence and the number.

15. The operating method according to claim 14, wherein the identifying the successive physical addresses searches for the information of the correspondence and the number corresponding to one of the read logical addresses.

16. The operating method according to claim 15, wherein the identifying the successive physical address loads the information of the correspondence and the number from the nonvolatile memory device into the memory in order to search for the information of the correspondence and the number corresponding to one of the read logical addresses.

17. The operating method according to claim 14, wherein the number of the identified physical addresses is equal to or less than the number of successive physical addresses corresponding to the read logical addresses.

18. The operating method according to claim 13, wherein the generating of the mapping table comprises:
generating in the memory a P2L mapping table, which is indexed by the physical address, and the write logical address and the number of successive physical addresses are mapped to the physical address; and
generating in the memory a L2P mapping table, which is indexed by the write logical address, and the physical address and the number of successive physical addresses are mapped to the write logical address, based on the P2L mapping table,
wherein the L2P mapping table is updated on the basis of the P2L mapping table.

19. The operating method according to claim 18, further comprising:
receiving read logical addresses for access to the nonvolatile memory device; and
identifying the successive physical addresses based on the read logical addresses and the information of the correspondence and the number.

20. The operating method according to claim 19, wherein the identifying the successive physical addresses searches for the information of the correspondence and the number corresponding to one of the read logical addresses in the P2L mapping table stored in the memory.
